(19) United States
(12) Patent Application Publication
(10) Pub. No.: US 2015/0264963 A1
(43) Pub. Date: Sep. 24, 2015

(54) GRANOLA COMPOSITION AND BAR CONTAINING STEEL CUT OATS AND PROCESS FOR MAKING THE SAME

(71) Applicant: MOM Brands Company, Lakeville, MN (US)

(72) Inventors: David Klaus Duffy, Maple Grove, MN (US); Joel Stefan Matasovsky, Golden Valley, MN (US)

(21) Appl. No.: 14/734,845

(22) Filed: Jun. 9, 2015

Related U.S. Application Data
(62) Division of application No. 13/791,056, filed on Mar. 8, 2013.
(60) Provisional application No. 61/733,685, filed on Dec. 5, 2012.

(51) Int. Cl. A23L 1/164

(52) U.S. Cl. CPC A23L 1/1643; A23V 2002/00

(57) ABSTRACT

Steel cut oat granola compositions comprising a grain component including steel cut oats, a conditioning syrup, and optionally additional grains, seeds, inclusions, sweeteners, flavorings, colors, oils, and emulsifiers are disclosed. A process for making the steel cut granola compositions of the disclosure is also disclosed in which conditioning syrup is readily absorbed by the steel cut oats to hydrate the steel cut oats and impart an acceptable texture and flavor to the granola composition. A steel cut oatmeal bar comprising the steel cut oat granola compositions and a cold forming process for making the steel cut granola bar in which a binder syrup exhibits reduced cold flow is also disclosed.

This application is a divisional of U.S. application Ser. No. 13/791,056 filed Mar. 8, 2013, which claims the benefit of U.S. Application Ser. No. 61/733,685 filed Dec. 5, 2012, both of which are hereby incorporated by reference in their entirety.

### BACKGROUND

Granola is a popular cereal and snack food that provides whole grain nutrition and offers the consumer numerous flavor and texture options dependent on the types of grains and inclusions incorporated into the granola. Likewise, granola bars are popular snack foods that, similar to granola, provide whole grain nutrition in a convenient, portable form. Granola and granola bars and are widely available in multiple different flavors and textures dependent on the types of grains, seeds, and inclusions and typically include oats as one bulk grain component.

The incorporation of oats provides a two-fold benefit. Oats are a low-cost, widely available ingredient that provides bulk and texture, but also a highly nutritious ingredient that provides many health benefits, such as lowering cholesterol, controlling blood sugar and weight control, by supplying dietary fiber, phytochemicals and other beneficial components. Granola and granola bars generally include rolled oats because rolled oats can be softened or cooked fast due to their size and structure, and provide a texture that is pleasing to the consumer. Rolled oats are traditionally produced by flattening hulled whole oats with rollers, and steaming and lightly toasting the flattened oats. When coated with binder syrup, the rolled oats readily absorb moisture from the syrup which imparts a soft, chewy texture to the granola.

Compared to rolled oats, steel cut oats provide the same health and nutritional benefits but are less processed, which is preferred by many consumers. However, granola and granola bars that include steel cut oats have not been accepted by consumers because raw steel cut oats are hard in texture and impart a bitter flavor and raw grain-like taste to the granola or granola bars. Previous attempts have been made to coat the steel cut oats in a sugar syrup and toast the coated oats in an oven, but the resultant granola is very hard in texture because the steel cut oats, unlike rolled oats, do not readily absorb moisture from the syrup.

Current manufacturing methods for producing granola or granola bars have been unable to provide a granola product comprising steel cut oats that satisfies consumer perceptions and expectations. A need therefore exits for granola products comprising steel cut oats that have a softer and chewy texture similar to granola products comprising rolled oats.

### SUMMARY

Granola compositions comprising a grain component including steel cut oats, a conditioning syrup, and optionally additional grains, seeds, inclusions, sweeteners, flavorings, colors, oils, and/or emulsifiers are disclosed. The steel cut oat granola compositions generally include steel cut oats treated with a conditioning syrup and may include clusters and/or nuggets of the granola ingredients bound together by the conditioning syrup. The steel cut granola compositions generally include about 60% to about 85% grain component by weight and about 15% to about 40% binder syrup by weight. The grain component generally comprises from about 50% to about 100% steel cut oats by weight. The conditioning syrup comprises water and one or more sugar components and has Brix (° Bx) of about 50° Bx to about 75° Bx. The conditioning syrup is mixed with the grain component and optional additional grains and/or inclusions under controlled temperature and time conditions to form a dough in which a portion of the conditioning syrup penetrates the steel cut oats and hydrates starches in the steel cut oats. The dough is then baked and cooled to form the steel cut oat granola composition.

A steel cut oatmeal bar comprising the steel cut oat granola compositions is also disclosed The steel cut oatmeal bar generally includes about 20% to about 50% by weight of the steel cut oat granola composition and about 25% to about 45% by weigh of a binder syrup comprising water, oil, one or more sugar components, and Brix of about 75° Bx to about 95° Bx. The steel cut oatmeal bar can optionally include additional grains and/or inclusions to provide a desired texture and/or taste. The binder syrup coats the granola composition and optional inclusions and additional grains in a cold forming process that exhibits reduced cold flow of the binder syrup. A portion of the binder syrup is absorbed by the granola composition in the cold flow process and hydrates the granola compositions to provide a steel cut oatmeal bar having a soft and chewy texture.

### BRIEF DESCRIPTION OF FIGURES

FIG. 1 shows a process for making a steel cut oat granola composition according to an embodiment.

FIG. 2 shows an embodiment of a steel cut oatmeal bar according to the disclosure.

FIG. 3 shows a process for making a steel cut oatmeal bar according to an embodiment.

FIG. 4 shows water absorption by steel cut oats according to an example.

### DETAILED DESCRIPTION

One aspect of the disclosure is steel cut oat granola compositions comprising a grain component including steel cut oats, a conditioning syrup, and optionally additional grains, seeds, inclusions, sweeteners, flavorings, colors, oils, and/or emulsifiers. The steel cut oat granola compositions generally include steel cut oats and other dry granola ingredients treated with a conditioning syrup and may include clusters and/or nuggets of the granola ingredients bound together by the conditioning syrup. The granola compositions can also be provided as clusters or nuggets and have a texture and flavor that satisfy consumer perceptions and expectations for a granola. A process for making the steel cut granola compositions of the disclosure is also disclosed in which the steel cut oats are “conditioned” with a syrup to make them palatable. The “conditioning” process softens and flavors the steel cut oats and is dependent on time, temperature, and syrup brix to hydrate the steel cut oats and impart a desirable texture and flavor to the steel cut oats.

Another aspect of the disclosure is a steel cut oatmeal bar. The steel cut oatmeal bar comprises a steel cut granola composition of the disclosure and is produced by a cold-forming process that reduces and/or prevents a binder syrup from running through the bar before the binder syrup is absorbed by the steel cut oats, which is known in the art as “cold flow”. In cold flow, the binder syrup runs though the bar and accumulates at the bottom of the bar resulting in bars that tend to fall apart and that are deformed in shape. The binder syrup disclosed herein reduces and/or prevents cold flow for a sufficient period of time to allow moisture from the binder syrup to equilibrate homogenously within the steel cut oats in the cold forming process to provide an oatmeal bar having a soft and chewy texture.

### I. Steel Cut Granola Compositions

Steel cut oat granola compositions are typically prepared by mixing dry granola ingredients with a syrup to form a dough, which can then be processed to form granola, clusters, nuggets, and/or bars. In order to obtain steel cut oats having a suitable texture and taste, it was discovered that steel cut oats can be conditioned in the granola production process to allow a conditioning syrup to effectively penetrate the steel coats oats to hydrate starches in the steel cut oats and impart a desirable flavor and texture to the steel cut oats, a process referred to herein as “conditioning”. The conditioning process softens and flavors the steel cut oats and is dependent on time, temperature, and syrup brix to hydrate the steel cut oats and impart a desirable texture and flavor to the steel cut oats. In an embodiment, the steel cut oats comprise a cooked flavor and texture.

The steel cut oat granola compositions of the disclosure are typically provided as a granola, which generally includes dry granola ingredients coated with a conditioning syrup and may include clusters and/or nuggets of the granola ingredients bound together by the conditioning syrup. The granola can also be provided in cluster or nugget form. The granola compositions generally include from about 60% to about 85% grain component by weight. In an embodiment, the granola composition comprises from 60% to about 70% grain component by weight. In another embodiment, the granola composition comprises from about 70% to about 80% grain component by weight. In another embodiment, the granola composition comprises from about 65% to about 75% grain component by weight. In another embodiment, the granola composition comprises from about 75% to about 85% grain component by weight.

The grain component typically comprises from about 50% to about 100% steel cut oats by weight. In an embodiment, the grain component comprises from about 50% to about 85% steel cut oats by weight. In an embodiment, the grain component comprises from about 60% to about 90% steel cut oats by weight. In an embodiment, the grain component comprises from about 75% to about 85% steel cut oats by weight. In another embodiment, the grain component comprises from about 75% to about 90% steel cut oats by weight.

The grain component can optionally include additional grains. Examples of these additional grains include corn, rice, wheat, rye, barley, oat groats, rolled oats, buckwheat, soybeans, puffed soy, and the like. The grain can be whole grain, hulled grain, flaked grain, rolled grain, cut grain, crisp grain, puffed grain, farina, grit, polenta, and mixtures thereof. In an embodiment, the granola composition comprises steel cut oats and oat groats, rolled oats, or a mixture thereof. The grain component typically includes from about 5% to about 50% by weight of the optional grain. In an embodiment, the granola composition comprises from about 10% to about 30% of the optional grain by weight. In another embodiment, the grain component comprises from about 5% to about 20% of the optional grain by weight. In another embodiment, the grain component comprises from about 5% to about 15% of the optional grain by weight. In another embodiment, the grain component comprises from about 10% to about 15% of the optional grain by weight. In yet another embodiment, the grain component comprises from about 5% to about 10% of the optional cereal grain by weight. In yet another embodiment, the grain component comprises about 50% to about 90% steel cut oats by weight and about 10% to about 30% rolled oats by weight. In yet another embodiment, the granola composition comprises about 75% to about 90% steel cut oats by weight and about 5% to about 20% rolled oats by weight.

Inclusions can optionally be added to the steel cut oat granola compositions of the disclosure to provide additional flavoring and/or texture. The inclusions are dispersed within or mixed, preferably homogenously, into the grain component of the granola compositions. Examples of inclusions include dehydrated fruit, coconut, nuts, seeds, additional grain pieces, chocolate or butterscotch chips or chunks, confections, and infused fruit. In an embodiment, the granola composition comprises from about 1% to about 30% inclusions by weight. In another embodiment, the granola composition includes from about 1% to about 20% by weight of inclusions. In yet another embodiment, the granola composition includes from about 1% to about 10% by weight of inclusions.

Examples of dehydrated fruit include apples, raisins, peaches, blueberries, cranberries, pineapple, strawberries, figs, prunes, dates, and the like. In an embodiment, the granola composition comprises from about 1% to about 20% dehydrated fruit by weight. In another embodiment, the granola composition includes from about 1% to about 10% dehydrated fruit by weight. In another embodiment, the granola composition includes from about 5% to about 10% dehydrated fruit by weight. In yet another embodiment, the granola composition includes from about 10% to about 15% dehydrated fruit by weight.

Examples of additional grain pieces include puffed or crisped grains such as corn, rice, wheat, rye, barley, oats, soybeans, and the like. In an embodiment, the granola composition comprises about 0% to about 10% additional grains by weight. In another embodiment, the granola composition comprises about 1% to about 10% additional grains by weight. In yet another embodiment, the granola composition comprises about 1% to about 5% additional grains by weight.

Examples of nuts include walnuts, pecans, almonds, peanuts, cashews, and the like. In an embodiment, the granola composition comprises from about 1% to about 15% nuts by weight. In an embodiment, the granola composition comprises from about 1% to about 10% nuts by weight. In another embodiment, the granola composition includes from about 1% to about 5% nuts by weight. In yet another embodiment, the granola composition comprises from about 0% to about 5% nuts by weight.

Examples of seeds include sunflower seeds, flax seeds, chia seeds, pumpkin seeds, hemp seeds, millet, and the like. In an embodiment, the granola composition comprises from about 1% to about 15% seeds by weight. In another embodiment, the granola composition includes from about 1% to about 8% seeds by weight.

The steel cut oat granola compositions of the disclosure typically include from about 15% to about 40% conditioning syrup by weight. The conditioning syrup functions to bind the dry ingredients, such as the grain component, seeds, nuts, and other inclusions, together to form the granola composition and provides moisture for hydration of the steel cut oats. In an embodiment, the granola composition comprises about 30% to about 40% conditioning syrup by weight. In another embodiment, the granola composition comprises about 20% to about 30% conditioning syrup by weight.

The conditioning syrup generally comprises water and one or more sugar components, and is generally provided as a slurry for coating the dry ingredients. The viscosity of the conditioning syrup can be controlled by regulating the amount of water in the syrup. The conditioning syrup generally comprises about 30% to about 70% water by weight. In an embodiment, the conditioning syrup comprises about 30% to about 60% water by weight. In an embodiment, the conditioning syrup comprises about 30% to about 50% water by weight. In an embodiment, the conditioning syrup comprises about 30% to about 40% water by weight.

The hydration of the steel cut oats and resultant texture of the hydrated steel cut oats can be controlled by the water content in the conditioning syrup. For purposes of this disclosure, the water content of the conditioning syrup is measured in units of degree Brix (° Bx). The conditioning syrup typically comprises about 50° Bx to about 75° Bx. In an embodiment, the conditioning syrup comprises about 50° Bx to about 60° Bx In another embodiment, the conditioning syrup comprises about 55° Bx to about 65° Bx. In another embodiment, the conditioning syrup comprises about 60° Bx to about 70° Bx. In another embodiment, the conditioning syrup comprises about 60° Bx to about 65° Bx. In another embodiment, the conditioning syrup comprises about 65° Bx to about 75° Bx. The sugar component of the conditioning syrup includes a sugar, corn syrup, such as high maltose corn syrup or high fructose corn syrup, white or brown rice, tapioca, oat, or other grain based syrups, a sugar alcohol, and mixtures thereof. Examples of sugars include, but are not limited to, glucose, fructose, dextrose, maltose, maltodextrin, corn syrup solids molasses, brown sugar, honey, barley malt, and the like. Examples of sugar alcohols include, but are not limited to, glycerin erthyritol, threitol, arabitol, xylitol, ribitol, mannitol, sorbitol, galactitol, fucitol, iditol, inositol, volemitol, isomalt, maltitol, lactitol, polyglycitol, and hydrogenated starch hydrosylates (HSH).

The sweetness of the conditioning syrup can be controlled by regulating the amount of sugar, corn syrup and/or sugar alcohol in the syrup, and/or by combining two or more sugars and/or sugar alcohols to provide the desired sweetness. In an embodiment, the conditioning syrup comprises about 30% to about 70% sugar by weight. In an embodiment, the conditioning syrup comprises about 55% to about 65% sugar by weight. In an embodiment, the conditioning syrup comprises about 50% to about 70% sugar by weight. In an embodiment, the conditioning syrup comprises about 30% to about 65% sugar by weight, about 0% to about 20% corn syrup by weight, and about 0% to about 8% sugar alcohol by weight. In an embodiment, the conditioning syrup comprises about 30% to about 65% sugar by weight and about 0.1% to about 20% corn syrup by weight. The amount of sugar in the granola composition can also be reduced by using high maltose corn syrup, which is less sweet than high fructose corn syrup, or combining the sugar component with one or more non-nutritive sweeteners, such as sucralose, aspartame, saccharin, cyclamates, or stevia, to obtain a conditioning syrup or granola composition having the desired level of sweetness.

The conditioning syrup can optionally include an oil component. The oil component of the conditioning syrup typically comprises from about 0% to about 20% of the conditioning syrup by weight. In an embodiment, the conditioning syrup comprises about 0.1% to about 20% of the conditioning syrup by weight. In another embodiment, the conditioning syrup comprises about 0.1% to about 10% oil by weight. In another embodiment, the conditioning syrup comprises 0% to about 5% oil by weight. In another embodiment, the conditioning syrup comprises about 0.1% to about 5% oil by weight. In another embodiment, the conditioning syrup comprises about 0.1% to about 2% oil by weight. In another embodiment, the conditioning syrup comprises about 0.1% to about 1% oil by weight. The oil is generally a vegetable oil. Examples of suitable vegetable oils include, but are not limited to, canola oil, palm oil, coconut oil, safflower oil, sunflower oil, olive oil, sesame oil, grapeseed oil, flax oil, walnut oil, peanut oil, and mixtures thereof.

The conditioning syrup can optionally include flavoring agents, salt, preservatives, colorants, fiber additive, and/or emulsifiers. Alternatively, one of more of these optional ingredients can be included with the dry granola ingredients including the steel cut oats and/or optional grains. The optional ingredients are typically mixed with the dry granola ingredients in the same amounts as when mixed into the conditioning syrup. Preferred salts include fine salt, extra fine salt, and flour salt. In an embodiment, the conditioning syrup comprises from about 0.05% to about 3% salt by weight. Suitable preservatives include tocopherols, ascorbic acid, butylated hydroxyanisole (BHA), butylated hydroxytoluene (BHT), and the like. In an embodiment, the conditioning syrup comprises from about 0.01 ppm to about 50 ppm preservatives by weight.

The flavoring agent can be a natural flavoring agent, artificial flavoring agent, or a mixture thereof. Examples of natural flavoring agents include vanilla, spices such as cinnamon, allspice, cloves, ginger, cassia, cocoa, chocolate, maple syrup solids, brown sugar, tea powders and dried fruit powders. Examples of artificial flavoring agents include maple flavor, butterscotch, vanilla, fruit flavors such as raspberry, strawberry, orange, apple and others. In an embodiment, the conditioning syrup comprises from about 0.1% to about 3% by weight of flavoring agent. In another embodiment, the conditioning syrup comprises from about 0.5% to about 1.5% by weight of flavoring agent.

Examples of colorants include caramel coloring, FD&C colorings such as blue no.1, blue no. 2, green no. 3, red no. 3, red no. 40, yellow no. 5, and yellow no. 6, and natural colors such as beta-carotenes, anthocyanins, annatto, chlorophyllin, cochineal, betanin, curcuminoids, and carotenoids. In an embodiment, the conditioning syrup comprises include from about 0.1% to about 5% colorants by weight.

Examples of fiber additives include oat bran, oat fiber, oat flour, flaxseed, soluble corn fiber, gum arabic, wheat germ, wheat bran, carboxymethylcellulose, and the like. In an embodiment, the conditioning syrup comprises from about 0.1% to about 5% by weight of fiber additive. In another embodiment, the conditioning syrup comprises from about 1% to about 4% by weight of fiber additive.

The conditioning syrup can include an emulsifier to prevent the oil and water in the syrup from separating. Examples of emulsifiers include lecithin, polyglycerol esters, sorbitan esters, monoglycerides, and diglycerides. In an embodiment, the conditioning syrup comprises from about 0% to about 2% emulsifier by weight. In another embodiment, the conditioning syrup comprises from about 0.1% to about 2% emulsifier by weight. In yet another embodiment, the conditioning syrup comprises from about 0.1% to about 1.5% emulsifier by weight.

Embodiments of conditioning syrup for a steel cut granola composition are shown in Table 1.

TABLE 1

| | Formulation A | Formulation B |
|---|---|---|
| Conditioning Syrup | (wt %) | (wt %) |
| Brix (°Bx) | 60-65 | 60-65 |
| Sugar | 60-65 | 60-65 |
| Water | 30-40 | 30-40 |
| Oil | 0 | 0-5 |
| Salt | 0.5-1.5 | 0.5-1.5 |
| Emulsifier | 0 | 0-2 |

Embodiments of steel cut oat granola compositions according to the disclosure are shown in Table 2.

TABLE 2

| | Formulation A | Formulation B | Formulation C |
|---|---|---|---|
| Granola Composition | (wt %) | (wt %) | (wt %) |
| Conditioning Syrup | 20-30 | 30-40 | 27-37 |
| Conditioning Syrup - | 60-65 | 60-65 | 60-65 |
| (°Bx) | | | |
| Steel cut oats | 60-70 | 60-70 | 15-25 |
| Rolled oats | 10-15 | 5-15 | 1-5 |
| Seeds/additional | 0-5 | 1-5 | 1-10 |
| grains | | | |
| Nuts | | | 1-10 |
| Dehydrated Fruit | | 1-10 | 1-15 |

The steel cut oat granola compositions of the disclosure typically have a moisture content between about 2% and about 6% water by weight. Granola having a moisture content above about 6% can be very sticky, which is typically considered to be undesirable by consumers. Granola having a moisture content below about 2% has a harder texture. In an embodiment, the granola composition comprises a moisture content of about 4% to about 6%. In another embodiment, the granola composition comprises a moisture content of about 2.5 to about 5.5.

In cluster form, the granola compositions of the disclosure typically have a particle size of about 0.3 cm to about 2 cm. In an embodiment, the clusters have a particle size of about 0.7 cm to about 1.2 cm. In nugget form, the granola compositions of the disclosure are generally provided as bit-size nuggets having a particle size of about 1.0 cm to about 4.0 cm. In an embodiment, the nuggets have a particle size of about 1.5 cm to about 2.0 cm. The granola compositions of the disclosure can be provided as a bulk composition, in single serving containers, such as a pouch, cup, or bowl, or in single serving packages, such as a wrapper or box.

The steel cut oat granola compositions of the disclosure are typically prepared by mixing the dry granola ingredients with the conditioning syrup to form a dough. The dry granola ingredients generally include the grain portion of the compositions, such as the steel cut oats and any additional grains, seeds, nuts, and other optional inclusions. In order to obtain steel cut oats having a suitable texture and taste, the water content, temperature, and brix of the conditioning syrup during the granola production process is engineered as described herein to allow the conditioning syrup to effectively penetrate the steel coats oats to hydrate the starches in the steel cut oats and impart a desirable flavor and texture to the steel cut oats. In an embodiment, the steel cut oats comprise a cooked flavor and texture.

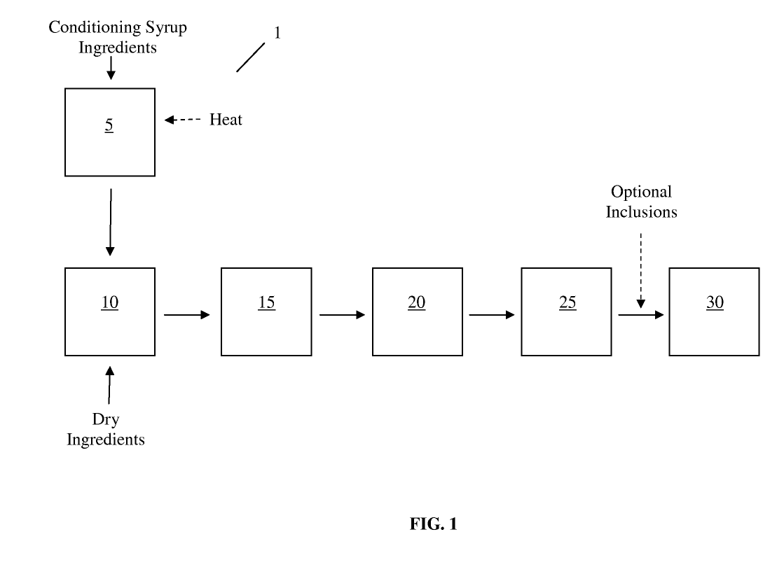

FIG. 1 shows an embodiment of a process (1) of making a steel cut oat granola compositions of the disclosure. The conditioning syrup is generally prepared by mixing together the conditioning syrup ingredients in a mixing kettle (5) and heating the ingredients to a temperature of about 100° F. to about 210° F. to form the conditioning syrup. In an embodiment, the sugar component and water are mixed together and heated to a temperature of about 110° F. to about 130° F. Dry syrup ingredients and any optional conditioning syrup ingredients, whether provided in wet or dry form, are added to the mixture with stirring and the mixture is heated to a temperature of about 140° F. to about 160° F. The optional oil is then added to the mixture with stirring and the mixture is heated to a temperature of about 140° F. to about 160° F. The optional emulsifier is then added to the mixture with stirring and the mixture is heated to a temperature of about 150° F. to about 170° F. Optional colorants and flavoring agents are then added to the mixture with stirring to form the final conditioning syrup.

The conditioning syrup is mixed with the dry granola ingredients to form a dough comprising an aggregated mass. The conditioning syrup functions to bind the grain component of the composition together and provides moisture for hydration of the steel cut oats. The conditioning syrup is generally mixed with the dry granola ingredients in a coating drum or mixer (10), such as batch mixer, a blender such, as a ribbon blender or dough blender, or in a continuous mixer, such as an auger blender.

The grain component is coated with an amount of conditioning syrup that coats the steel cut oats with an amount of conditioning syrup that provides sufficient moisture to adequately penetrate the steel cut oats. The ratio of conditioning syrup to steel cut oats generally is from about 1:1 to about 1:6. In an embodiment, the ratio of conditioning syrup to steel cut oats comprises from about 1:1 to about 1:1.5. In an embodiment, the ratio of conditioning syrup to steel cut oats comprises from about 1:4 to about 1:6. In another embodiment, the ratio of conditioning syrup to steel cut oats comprises from about 1:3 to about 1:4.

The dough is held at a temperature generally between about 120° F. to about 210° F. and then baked in an oven (15) for about 5 minutes to about 20 minutes to facilitate hydration of the starches in the steel cut oats. In an embodiment, the heated conditioning syrup comprises a temperature of about 120° F. to about 210° F. In another embodiment, the heated conditioning syrup comprises a temperature of about 140° F. to about 210° F. In another embodiment, the heated conditioning syrup comprises a temperature of about 150° F. to about 210° F. In yet another embodiment, the heated conditioning syrup comprises a temperature of about 140° F. to about 160° F. In yet another embodiment, the heated conditioning syrup comprises a temperature of about 150° F. to about 180° F. In yet another embodiment, the heated conditioning syrup comprises a temperature of about 180° F. to about 210° F. In yet another embodiment, the conditioning syrup comprises a temperature of about 190° F. to about 210° F. In yet another embodiment, the heated conditioning syrup comprises a temperature of about 195° F. to about 205° F.

In an embodiment, the dough is held at a temperature between about 140° F. to about 210° F. for about 30 seconds to about 5 minutes. In another embodiment, the dough is held at a temperature between about 140° F. to about 160° F. for about 30 seconds to about 5 minutes. In another embodiment, the dough is held at a temperature between about 190° F. to about 210° F. for about 30 seconds to about 5 minutes.

The dough is baked for about 5 minutes to about 20 at a temperature that does not drive off the moisture in the syrup through evaporation before a sufficient amount of moisture penetrates into the steel cut oats. If the dough is subjected to too much heat and/or is heated for too little time the water in the conditioning syrup flashes off the outside of the steel cut oats without penetrating the grain. In an embodiment, the dough is baked for about 5 minutes to about 20 minutes at a temperature of about 200° F. to about 325° F. In another embodiment, the dough is baked for about 10 minutes to about 20 minutes at a temperature of about 275° F. to about 300° F. In an embodiment, the baked dough comprises about 2% to about 6% water by weight.

The baked dough is then cooled by a cooling operation (20) and temperature sensitive inclusions that would undesirably melt during the baking process, such as chocolate or confectionary pieces, can be blended into the cooled product. The baked dough is typically cooled to a temperature of about 90° F. to 110° F. before the inclusions are blended into the dough. To prevent undesirable melting of the inclusions, the inclusions can be refrigerated or frozen before blending with the cooled product. In the cooling operation (20), the oven (15) can be configured to include a cooling section in which air is blown over the baked dough to cool the baked dough as it passes though the cooling section of the oven. Alternatively, the cooling operation (20) can be configured to include a chiller to cool the baked dough.

During the baking and cooling processes, the dough may form aggregates or an aggregated mass that require reduction in size prior to packaging of the finished product. Following cooling, the aggregates or aggregated mass are reduced to a desired particle size in a sizing operation (25). In an embodiment, an aggregated mass of baked dough is cooled to about 55° F. to about 110° F. and then broken into clusters or nuggets in the sizing operation (25). The finished product is then packaged in a packaging operation (30). Additional inclusions, such as temperature sensitive inclusions that would undesirably melt and/or cook during the baking process, can be blended into the sized product prior to the packaging operation to form the finished product. In the packaging operation (30), finished steel cut oat granola composition can be packaged as a bulk composition or into a single serving or multi-serving bag, pouch, cup, bowl, wrapper, and the like.

### II. Steel Cut Oatmeal Bar

Another aspect of the disclosure is a steel cut oatmeal bar comprising a steel cut oat granola composition of the disclosure. The steel cut oatmeal bar is produced by a cold forming process in which binder syrup exhibits reduced cold flow. Because steel cut oats are much thicker and have less surface area compared to traditional rolled oats, it takes significantly more time for moisture in the binder syrup to penetrate the steel cut oats. A conventional granola bar syrup at ambient temperature runs through the steel cut oatmeal bar before the syrup is absorbed by the steel cut oats and accumulates at the bottom of the bar. This “cold flow” can occur during processing and creates a mess of syrup over the conveyor belts and packaging equipment in the production process. Cold flow can also occur after the bars are packaged resulting in deformed bars that are thicker and denser at the bottom of the bar compared to the top of the bar. The binder syrup of the disclosure reduces and/or prevents cold flow for a sufficient period of time to allow moisture from the binder syrup to equilibrate homogenously within the steel cut oats over a number of days and/or weeks providing an oatmeal bar having a soft and chewy texture.

The steel cut oatmeal bar generally includes a steel cut oat granola composition of the disclosure, a binder syrup, and optionally additional grains, seeds, inclusions, sweeteners, flavorings, colors, oils, and/or emulsifiers. The binder syrup binds the steel cut granola composition and optional ingredients and/or inclusions together to provide the shaped form of the bar. The steel cut oatmeal bar can be provided in a single serving or multi-serving package, such as a wrapper, box, or pouch, that provides for easy and convenient consumption by a consumer. The steel cut oatmeal bar typically has a single serving weight of about 20 grams (g) to about 40 g, a width of about 2 cm to about 6 cm, a length of about 4 cm to about 10 cm, and a thickness of about 0.5 cm to about 2.5 cm. The steel cut oatmeal bar can also be provided in the shape of an animal or novelty character, or other geometric shapes as desired.

The steel cut oatmeal bar generally includes from about 20% to about 50% by weight of a granola composition of the disclosure. In an embodiment, the bar comprises about 30% to about 50% granola composition by weight. In another embodiment, the bar comprises about 20% to about 35% granola composition by weight. In another embodiment, the bar comprises about 30% to about 40% granola composition by weight. In yet another embodiment, the bar comprises about 40% to about 50% granola composition by weight.

Inclusions can optionally be added to the steel cut oatmeal bar to provide additional flavoring and/or texture. For purposes of clarity, inclusions added to the steel cut oatmeal bar are termed “secondary inclusions” as these inclusions may be secondary to inclusions present in the steel cut granola composition, although the granola composition may not include any inclusions. The “secondary inclusions” are dispersed within or mixed, preferably homogenously, into the steel cut oatmeal bar. Reference to the weight percentage of secondary inclusions in the bar is exclusive of any inclusions that may be present in the granola composition. In an embodiment, the steel cut oatmeal bar comprises from about 1% to about 40% secondary inclusions by weight. In another embodiment, the bar includes from about 1% to about 30% by weight of secondary inclusions. In another embodiment, the bar includes from about 1% to about 20% by weight of secondary inclusions. In yet another embodiment, the bar includes from about 1% to about 15% by weight of secondary inclusions. In yet another embodiment, the bar includes from about 1% to about 10% by weight of secondary inclusions.

Examples of secondary inclusions include dehydrated fruit, coconut, nuts, seeds, additional grain pieces, chocolate or butterscotch chips or chunks, confections, and infused fruit. In an embodiment, the steel cut oatmeal bar comprises about 1% to about 10% chocolate, butterscotch, or other confectionary pieces by weight. In another embodiment, the bar comprises about 5% to about 10% chocolate, butterscotch, or other confectionary pieces by weight.

Examples of dehydrated fruit include apples, raisins, peaches, blueberries, cranberries, pineapple, strawberries, figs, prunes, dates, and the like. In an embodiment, the steel cut oatmeal bar comprises from about 1% to about 20% dehydrated fruit by weight. In another embodiment, the bar comprises from about 1% to about 10% dehydrated fruit by weight. In another embodiment, the bar comprises from about 5% to about 10% dehydrated fruit by weight. In yet another embodiment, the bar comprises from about 10% to about 15% dehydrated fruit by weight.

Examples of additional grain pieces include puffed or crisped grains such as corn, rice, wheat, rye, barley, oats, soybeans, and the like. In an embodiment, the steel cut oatmeal bar comprises about 0% to about 10% additional grains by weight. In another embodiment, the bar comprises about 1% to about 10% additional grains by weight. In another embodiment, the bar comprises about 1% to about 5% additional grains by weight. In yet another embodiment, the bar comprises about 3% to about 8% additional grains by weight.

Examples of nuts include walnuts, pecans, almonds, peanuts, cashews, and the like. In an embodiment, the steel cut oatmeal bar comprises from about 1% to about 15% nuts by weight. In an embodiment, the bar comprises from about 10% to about 15% nuts by weight. In another embodiment, the bar comprises from about 1% to about 10% nuts by weight. In another embodiment, the bar comprises from about 1% to about 5% nuts by weight. In yet another embodiment, the bar comprises from about 0.1% to about 5% nuts by weight.

Examples of seeds include sunflower seeds, flax seeds, chia seeds, pumpkin seeds, hemp seeds, millet, and the like. In an embodiment, the steel cut oatmeal bar comprises from about 1% to about 15% seeds by weight. In another embodiment, the bar comprises from about 1% to about 10% seeds by weight. In another embodiment, the bar comprises from about 1% to about 8% seeds by weight. In yet another embodiment, the bar comprises from about 1% to about 5% seeds by weight.

The steel cut oatmeal bar typically includes from about 25% to about 45% binder syrup by weight. The binder syrup functions to bind the granola composition and inclusions together to form the steel cut oatmeal bar. The binder syrup also provides moisture for hydrating the steel cut oat granola composition to form a steel cut oatmeal bar having a soft and chewy texture. In an embodiment, the steel cut oatmeal bar comprises about 30% to about 40% binder syrup by weight. In another embodiment, the bar comprises about 20% to about 30% binder syrup by weight. In yet another embodiment, the bar comprises about 25% to about 35% binder syrup by weight. In yet another embodiment, the bar comprises about 35% to about 45% binder syrup by weight.

The binder syrup generally comprises water, oil, one or more sugar components, and one or more gums. The hydration of the steel cut oat granola composition and resultant texture of the steel cut oatmeal bar can be controlled by the water content in the binder syrup and viscosity of the binder syrup. Preferably, the viscosity of the binder syrup increases as the temperature of the binder syrup decreases to prevent and/or reduce cold flow. In an embodiment, the viscosity of the binder syrup increases between about 150° F. to about 80° F. to reduce cold flow of the binder syrup. For purposes of this disclosure, the water content of the binder syrup is measured in units of degree Brix (° Bx). The binder syrup typically comprises about 75° Bx to about 90° Bx. In an embodiment, the binder syrup comprises about 75° Bx to about 85° Bx. In another embodiment, the binder syrup comprises about 80° Bx to about 90° Bx. In another embodiment, the binder syrup comprises about 80° Bx to about 85° Bx. In another embodiment, the binder syrup comprises about 85° Bx to about 90° Bx. In another embodiment, the binder syrup comprises about 82° Bx to about 88° Bx.

The sugar component of the binder syrup can include a sugar, corn syrup, such as high maltose corn syrup or high fructose corn syrup, white or brown rice, tapioca, oat or other grain based syrups, a sugar alcohol, and mixtures thereof. Examples of sugars include, but are not limited to, glucose, fructose, dextrose, maltose, maltodextrin, corn syrup solids, brown sugar, honey, barley malt, and the like. Examples of sugar alcohols include, but are not limited to, glycerin erthyritol, threitol, arabitol, xylitol, ribitol, mannitol, sorbitol, galactitol, fucitol, iditol, inositol, volemitol, isomalt, maltitol, lactitol, polyglycitol, and hydrogenated starch hydrosylates (HSH).

The sweetness of the binder syrup can be controlled by regulating the amount of sugar, corn syrup and/or sugar alcohol in the syrup, and/or by combining two or more sugars and/or sugar alcohols to provide the desired sweetness. In an embodiment, the binder syrup comprises about 0% to about 20% sugar by weight, about 30% to about 65% corn syrup by weight, and about 0% to about 10% sugar alcohol by weight. In another embodiment, the binder syrup comprises about 30% to about 65% corn syrup by weight, about 0.1% to about 20% sugar by weight, and about 0.1% to about 10% sugar alcohol by weight. In another embodiment, the binder syrup comprises about 4% to about 20% sugar and about 40% to about 60% of corn syrup. In another embodiment, the binder syrup comprises about 4% to about 20% sugar, about 40% to about 60% of corn syrup, and about 5% to about 15% sugar alcohol. In yet another embodiment, the binder syrup comprises about 1% to about 15% maltodextrin by weight, about 45% to 65% corn syrup by weight, and about 1% to about 10% sugar alcohol by weight. The amount of sugar in the steel cut oatmeal bar can also be reduced by using high maltose corn syrup, which is less sweet than high fructose corn syrup, or combining the sugar component with one or more non-nutritive sweeteners, such as sucralose, aspartame, saccharin, cyclamates, or stevia, to obtain a binder syrup or steel cut oatmeal bar having the desired level of sweetness.

The one or more gum components comprise from about 1% to about 6% of the binder syrup by weight and functions to increase the viscosity of the binder syrup as it cools to reduce and/or prevent cold flow of the binder syrup in the cold forming process of the disclosure for making a steel cut oatmeal bar for a sufficient time to allow moisture in the binder syrup to equilibrate homogenously within the steel cut oats. Examples of suitable gums include but are not limited to gum arabic, carboxymethylcellulose gum, cellulose gum, guar gum, xanthan gum, locust bean gum, gum tragacanth, alternan, tragacanth, carrageenan, gelatin, and mixtures thereof. In an embodiment, the gum comprises gum arabic. In an embodiment, the binder syrup comprises about 1.5% to about 6% gum by weight. In another embodiment, the binder syrup comprises about 2% to about 6% gum by weight. In another embodiment the binder syrup comprises about 2.5% to about 6% gum by weight. In another embodiment, the binder syrup comprises about 3% to about 6% gum by weight. In another embodiment, the binder syrup comprises about 3% to about 5% gum by weight.

The oil component of the binder syrup typically comprises from about 0% to about 25% of the binder syrup by weight. In an embodiment, the binder syrup comprises about 0.1% to about 25% oil by weight. In another embodiment, the binder syrup comprises about 0.1% to about 20% oil by weight. In another embodiment, the binder syrup comprises about 0.1% to about 10% oil by weight. In another embodiment, the binder syrup comprises about 8% to about 20% oil by weight. In another embodiment, the binder syrup comprises about 10% to about 15% oil by weight. The oil is generally a vegetable oil. Examples of suitable vegetable oils include, but are not limited to, canola oil, palm oil, coconut oil, safflower oil, sunflower oil, olive oil, sesame oil, grapeseed oil, flax oil, walnut oil, peanut oil, and mixtures thereof.

The binder syrup can optionally include flavoring agents, salt, preservatives, colorants, fiber additive, and/or emulsifiers. Alternatively, one of more of these optional ingredients can be mixed with the steel cut granola composition when forming the bar. For the steel cut oatmeal bar, the optional ingredients are typically mixed with the steel cut granola composition in the same amounts as when mixed into the binder syrup. Preferred salts include fine salt, extra fine salt, and flour salt. In an embodiment, the binder syrup comprises from about 0.05% to about 3% salt by weight. Suitable preservatives include tocopherols, ascorbic acid, butylated hydroxyanisole (BHA), butylated hydroxytoluene (BHT), and the like. In an embodiment, the binder syrup comprises from about 0.01 ppm to about 50 ppm preservatives by weight.

The flavoring agent can be a natural flavoring agent, artificial flavoring agent, or a mixture thereof. Examples of natural flavoring agents include vanilla, spices such as cinnamon, allspice, cloves, ginger, cassia, cocoa, chocolate, maple syrup solids, brown sugar, tea powders and dried fruit powders. Examples of artificial flavoring agents include maple flavor, butterscotch, vanilla, fruit flavors such as raspberry, strawberry, orange, apple and others. In an embodiment, the binder syrup comprises from about 0% to about 3% by weight of flavoring agent. In an embodiment, the binder syrup comprises from about 0.1% to about 3% by weight of flavoring agent. In another embodiment, the binder syrup comprises from about 0.5% to about 1.5% by weight of flavoring agent.

Examples of colorants include caramel coloring, FD&C colorings such as blue no.1, blue no. 2, green no. 3, red no. 3, red no. 40, yellow no. 5, and yellow no. 6, and natural colors such as beta-carotenes, anthocyanins, annatto, chlorophyllin, cochineal, betanin, curcuminoids, and carotenoids. In an embodiment, the binder syrup comprises include from 0% to about 5% colorants by weight. In another embodiment, the binder syrup comprises include from about 0.1% to about 5% colorants by weight. In another embodiment, the binder syrup comprises include from about 0.1% to about 3% colorants by weight.

Examples of fiber additives include oat bran, oat fiber, oat flour, flaxseed, soluble corn fiber, gum arabic, wheat germ, wheat bran, carboxymethylcellulose, and the like. In an embodiment, the binder syrup comprises from about 0.1% to about 12% by weight of fiber additive. In another embodiment, the binder syrup comprises from about 8% to about 12% by weight of fiber additive. In another embodiment, the binder syrup comprises from about 1% to about 4% by weight of fiber additive.

The binder syrup can include an emulsifier to prevent the oil and water in the binder syrup from separating. Examples of emulsifiers include lecithin, polyglycerol esters, sorbitan esters, monoglycerides, and diglycerides. In an embodiment, the binder syrup comprises from about 0.5% to about 2% emulsifier by weight.

Embodiments of the binder syrup for the steel cut oatmeal bar of the disclosure are shown in Table 3.

TABLE 3

| | Formulation A | Formulation B |
|---|---|---|
| Binder Syrup | (wt %) | (wt %) |
| Brix (°Bx) | 82-86 | 83-87 |
| Maltodextrin | 4.5-6.5 | 10-12 |
| Corn Syrup | 54-58 | 52-57 |
| Sugar Alcohol | 6.5-8.5 | 7-9 |
| Gum | 1-6 | 1-6 |
| Oil | 3-5 | 1-3 |
| Salt | 0.5-1.5 | 0.5-1.5 |
| Emulsifier | 0.5-1.5 | 0.1-0.5 |
| Flavoring Agent | 1-3 | 0.5-1.5 |
| Fiber Additive | 8-12 | 8-12 |
| Preservatives | 0.1-0.2 | 0.15-0.35 |

Embodiments of a steel cut oatmeal bar according to the disclosure are shown in Table 4.

TABLE 4*

| | Formulation A | Formulation B | Formulation C |
|---|---|---|---|
| Bar | (wt %) | (wt %) | (wt %) |
| Binder Syrup | 33-43 | 33-43 | 27-37 |
| Binder Syrup - (°Bx) | 80-90 | 80-90 | 80-90 |
| Steel Cut Granola | 30-50 | 30-50 | 20-35 |
| Composition | | | |
| Seeds | 1-5 | 1-5 | 5-10 |
| Nuts | | | 10-15 |
| Dehydrated Fruit | 5-10 | | 10-15 |
| Additional grain | 3-8 | 3-8 | 3-8 |
| Chocolate or | | 5-10 | |
| confectionary pieces | | | |

*Weight percentages of seeds, nuts, dehydrated fruit, additional grain, and chocolate or confectionary pieces in Table 4 are exclusive of the granola composition.

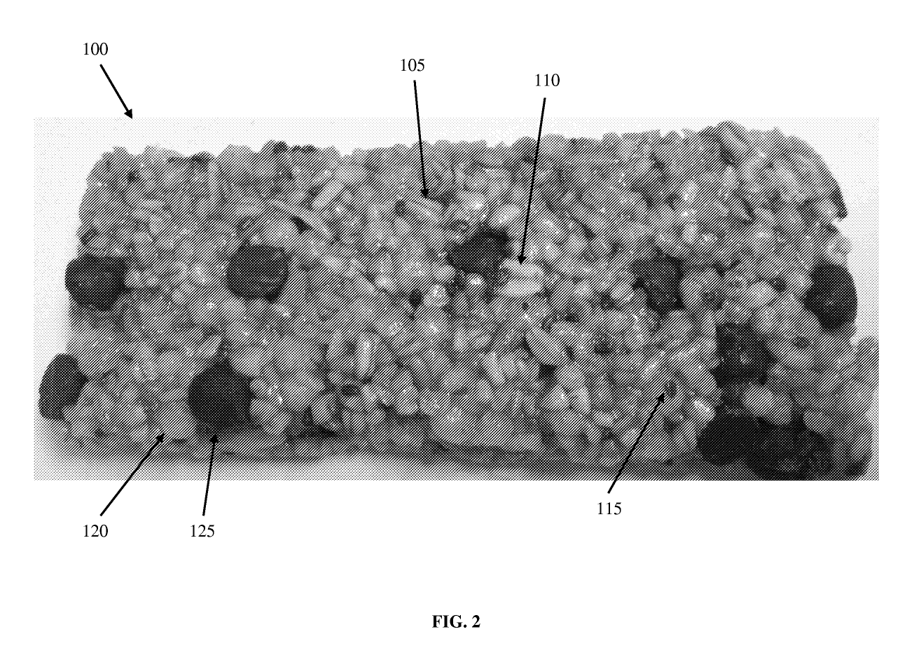

One embodiment of a steel cut oatmeal bar of the disclosure is shown in FIG. 2. As shown in FIG. 2, the steel cut oatmeal bar (100) contains steel cut oats (105), rolled oats (110), crisp rice (115), chia seeds (120), and chocolate chips (125) in a homogenous mixture bound together by binder syrup to from the bar. The steel cut oatmeal bar can also be provided in the shape of an animal or novelty character, or other geometric shapes as desired. In embodiments, the steel cut oatmeal bar can be enrobed and/or decorated with a chocolate, yogurt, or other confectionary coating.

The steel cut oatmeal bar is typically prepared by mixing the steel cut oat granola composition with the binder syrup in a cold forming process that does not require baking and exhibits reduced cold flow of the binder syrup. Because steel cut oats are much thicker and have less surface area compared to traditional rolled oats, it takes significantly more time for moisture in the binder syrup to penetrate the steel cut oats. A conventional granola bar syrup at ambient temperature runs through the steel cut oatmeal bar before the syrup is absorbed by the steel cut oats and accumulates at the bottom of the bar. Cold flow can occur during processing of the bar creating a mess of syrup over the conveyor belts and packaging equipment in the production process. Cold flow can also occur after the bars are packaged resulting in deformed bars that are thicker and denser at the bottom of the bar compared to the top of the bar. The binder syrup of the disclosure reduces and/or prevents cold flow for a sufficient period of time in the cold forming process to allow moisture from the binder syrup to equilibrate homogenously within the steel cut oats over a number of days and/or weeks providing an oatmeal bar having a soft and chewy texture.

The binder syrup coats the steel cut granola composition and optional ingredients and/or inclusions and binds them together to provide the steel cut oatmeal bar. A portion of the binder syrup absorbs into the steel cut granola composition over time thereby hydrating the granola composition and providing a steel cut oatmeal bar producing having a soft and chewy texture. The water content and viscosity of the binder syrup can be engineered as described herein to reduce and/or prevent cold flow to allow the binder syrup to effectively penetrate and hydrate the steel cut oat granola composition to impart the steel cut oatmeal bar with the desired flavor and texture. Moisture from the binder syrup is absorbed by the steel cut oats the during the production process and can continue after packaging the bar for days and/or weeks until the moisture equilibrates homogenously with the steel cut oats in the bar without significant cold flow of the binder syrup. In an embodiment, the steel cut oatmeal bar comprises from about 6% to about 14% water by weight. In an embodiment, equilibration of moisture in the bar occurs within 1-30 days of producing the bar. In another embodiment, equilibration of moisture in the bar occurs within 3-21 days of producing the bar. In another embodiment, equilibration of moisture in the bar occurs within 7-21 days of producing the bar. In yet another embodiment, equilibration of moisture in the bar occurs within 7-14 days of producing the bar.

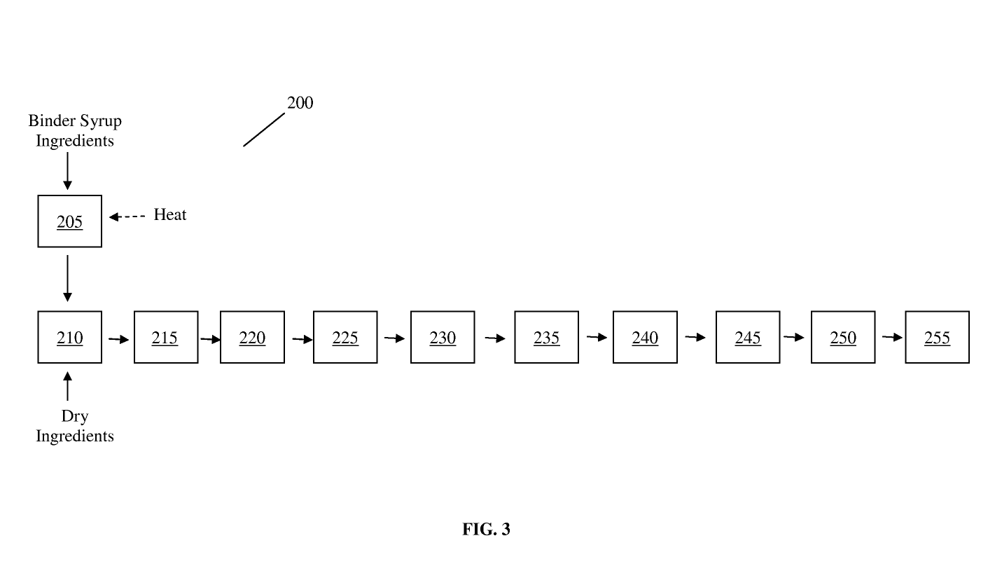

FIG. 3 shows an embodiment of a process (200) for making a steel cut oatmeal bar of the disclosure. The binder syrup is generally prepared by mixing together the binder syrup ingredients in a mixing kettle (205) and heating the ingredients to a temperature of about 100° F. to about 180° F. to form the binder syrup. In an embodiment, the sugar component and water are mixed together and heated to a temperature of about 110° F. to about 130° F. Dry syrup ingredients and any of the optional binder syrup ingredients, whether provided in wet or dry form, are added to the mixture with stirring and the mixture is heated to a temperature of about 140° F. to about 160° F. Oil is then added to the mixture with stirring and the mixture is heated to a temperature of about 140° F. to about 160° F. The optional emulsifier is then added to the mixture with stirring and the mixture is heated to a temperature of about 150° F. to about 170° F. Optional colorants and flavoring agents are then added to the mixture with stirring to form the final binder syrup.

The binder syrup is mixed with the steel cut oat granola composition and optional ingredients and/or inclusions, with the exception of temperature sensitive inclusions such as chocolate, chocolate chips, or other confectionary pieces that could melt in the presence of the heated binder syrup, to form an aggregated mass. The binder syrup is generally mixed with the steel cut granola composition and optional ingredients and/or inclusions in a coating drum or mixer (210), such as batch mixer, a blender such as a ribbon blender or dough blender, or in a continuous mixer, such as an auger blender. The aggregated mass is formed into a slab by an extruder or rollers (215). The slab is compressed by one or more compression rolls (220). Optional chips or other confectionary pieces can be added to the compressed slab by a depositor (225). The compressed slab in then cooled in a cooling tunnel (230). In an embodiment, the compressed slab is cooled to a temperature of about 60° F. to 75° F. The cooled slab is then slit with a slitter (235) and cut with a guillotine (240) to form individual bars. The bars are optionally coated and/or decorated with chocolate, yogurt, or other confectionary coating with an enrober (245) and then cooled in a second cooling tunnel (250). In an embodiment, the enrobed and/or decorated bars are cooled to about 55° F. to about 70° F. The finished bars are then packaged in a packaging operation (255). In the packaging operation (255), the finished bars can be packaged in bulk or into a single serving or multi-serving bag, pouch, cup, bowl, wrapper, and the like.

### EXAMPLES

The following example is illustrative, and other embodiments exist and are within the scope of the present invention.

### Example 1

A method of making a steel cut oatmeal bar is described. A binder syrup was prepared by adding about 55 parts 43% high maltose corn syrup, about 3 parts water, and about 8 parts glycerin into a mixing bowl and heating to 120° F. while mixing. About 11 parts maltodextrin, about 6 parts dietary fiber, about 3 parts gum, and about 1 part salt flour were mixed together and added into the mixing bowl. The mixture was mixed until all solids were dissolved and then heated to 175° F. About two parts of a vegetable oil was mixed into the heated mixture, and the mixture was heated to 160° F. About 1 part chocolate flavor was added and mixed into the binder syrup.

While maintaining a temperature of about 160° F., the binder syrup was mixed with steel cut oat granola, about 2 parts soy crisps, and about 3 parts crisp rice at a ratio of about 0.2 to about 0.3 binder syrup to steel cut oats to form an aggregated mass. Mixing at the elevated temperature was continued until all dry granola ingredients were thoroughly coated with binder syrup and the steel cut oats were cooked. The aggregated mass was then cooled to about 95° F. and about 8 parts of chocolate chips were added to the mass. The aggregated mass was then pressed into a slab on a pan and cooled to about 60° F. The slab was cut to 1.25 inch wide by 3.5 inch long bars that weighed about 35 grams each.

### Example 2

A steel cut oat granola composition was prepared at different temperatures using conditioning syrup comprising different moisture levels to study the effect of moisture and temperature on hydration of the steel cut oats and to determine a moisture level in the conditioning syrup that provided a steel cut granola composition having the desired texture, color, and flavor profile. The granola was prepared in a process as shown in FIG. 1. The water level was varied between batches to provide conditioning syrup having about 65° Bx to about 75° Bx. Conditioning syrup having a temperature between about 150° F. and about 200° F. was mixed with steel cut oats (about 85% steel cut oats, 15% rolled oats) at a ratio of about 0.22 to about 0.28 conditioning syrup to steel cut oats for about 30 seconds to about 10 minutes and then baked at about 300° F. for about 12 to about 20 minutes. Table 5 shows the effects of conditioning syrup temperature and Brix, syrup mix and hold times with oats, and baking conditions on the finished granola composition's moisture and sensory characteristics.

TABLE 5

| | | | | | | | | | Flavor | | |
|---|---|---|---|---|---|---|---|---|---|---|---|
| | | | | | | | Texture | | | Brown/ | Color |
| | | | | | | | Hard/Soft | Gritty/ | | Nutty/ | light/ |
| Syrup | | Mix | Hold | Bake | | Granola % | (toothpack) | Smooth | Raw/Ckd | burnt | dark |
| Temp | Brix | Time | Time | Temp | Time | Moisture | 1 to 5 | 1 to 5 | 1 to 5 | 1 3 5 | 1 to 5 |
| 200 | 69 | 30 sec | <1 min | 300 | 12 | 5.25 | 3.5 | 2.5 | 2 | 1 | 1 |
| 200 | 69 | 30 sec | <1 min | 300 | 16 | 3.94 | 2.5 | 2.5 | 2.5 | 1 | 1.5 |
| 200 | 69 | 30 sec | <1 min | 300 | 20 | 2.70 | 2 | 2.5 | 2.5 | 3 | 1.75 |
| 200 | 75 | 2 min | <1 min | 300 | 12 | 3.10 | 3 | 2.5 | 2 | 1 | 2 |
| 200 | 75 | 2 min | <1 min | 300 | 16 | 2.81 | 2.5 | 2.5 | 2.5 | 3 | 2.25 |
| 200 | 75 | 2 min | <1 min | 300 | 20 | 3.23 | 2 | 2 | 3 | 3 | 2.5 |
| 150 | 65 | 30 sec | <1 min | 300 | 12 | 5.72 | 4 | 2 | 1.5 | 2 | 1 |
| 150 | 65 | 30 sec | <1 min | 300 | 16 | 3.81 | 3 | 2 | 2 | 2 | 1 |
| 150 | 65 | 2 min | <1 min | 300 | 12 | 4.81 | 4.5 | 2 | 1.5 | 2 | 1 |
| | | | | | edge | | | | | | |
| 150 | 65 | 2 min | <1 min | 300 | 16 | 4.85 | 4 | 2.5 | 2.5 | 2 | 1 |
| 150 | 65 | 2 min | <1 min | 300 | 20 | 2.59 | 3 | 3 | 3 | 2 | 1.5 |
| 156 | 66 | 5 min | <1 min | 300 | 12 | 3.82 | 4.5 | 2 | 1 | 2 | 1 |
| 156 | 66 | 5 min | <1 min | 300 | 16 | 4.16 | 5 | 2.5 | 1 | 2 | 1 |
| 156 | 66 | 5 min | <1 min | 300 | 20 | 2.85 | 4 | 2 | 2 | 3 | 1.5 |

The steel cut oats were found to absorb the most water at a conditioning syrup temperature of 200° F. and mixing time between 2 minutes to about 10 minutes. As shown in Table 5, granola having a moisture content of about 2.5% to about 4% was found to provide both good texture and flavor. Granola having a moisture content above about 5% was found to be undesirably sticky. Granola having a moisture content below about 2 was found to be too hard.

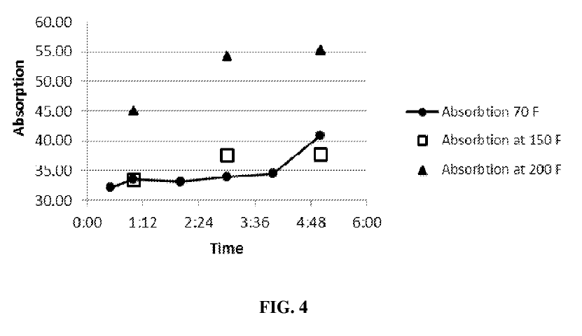

FIG. 4 shows moisture absorption by the steel cut oats as a function of hold time prior to baking As shown in FIG. 4, the steel cut oats absorbed more moisture from the conditioning syrup at higher temperatures than at lower temperatures. The hydration rate of the steel cut oats was found to decrease after about 3 minutes.

The texture of the steel cut granola composition was evaluated based on toothpack (hard to soft on a scale of 1 to 5) and smoothness (gritty to smooth on a scale of 1 to 5). A toothpack of about 2 to about 3 and smoothness of about 2 to about 2.5 was determined to provide the most desirable texture. The flavor of the steel cut granola composition was evaluated based on cooked flavor (raw to cooked on a scale of 1 to 5) and nutty flavor (brown=1, nutty=3, burnt, =5). Unconditioned steel cut oats were hard like bird seeds and had a raw, uncooked flavor. A cooked flavor of about 2 to about 3 and a nutty flavor (3) were determined to provide the most desirable flavor. The color of the steel cut granola composition was evaluated on a scale of 1 to 5 (light to dark) and a color of about 2 to about 2.5 was determined to provide the most desirable color. Conditioning syrup of about 69 to about 75° Bx, a mixing time between about 30 seconds and 2 minutes at about 200° F., and a baking time between about 12 minutes to 20 minutes at about 300° F. was found to provide a steel cut oat granola composition having a texture, flavor, and color that satisfied consumer perceptions and expectations for a granola.

While certain embodiments of the invention have been described, other embodiments may exist. While the specification includes a detailed description, the invention's scope is indicated by the following claims. Furthermore, while the specification has been described in language specific to structural features and/or methodological acts, the claims are not limited to the features or acts described above. Rather, the specific features and acts described above are disclosed as illustrative aspects and embodiments of the invention. Various other aspects, embodiments, modifications, and equivalents thereof which, after reading the description herein, may suggest themselves to one of ordinary skill in the art without departing from the spirit of the present invention or the scope of the claimed subject matter.

What is claimed is:

1. A granola composition comprising:
about 60% to about 85% grain component by weight, wherein the grain component comprises from about 50% to about 100% steel cut oats by weight; and
about 15% to about 40% of conditioning syrup by weight, the conditioning syrup comprising water and one or more sugar components, and Brix (° Bx) of about 50° Bx to about 75° Bx.

2. The granola composition of claim 1, wherein the composition comprises clusters or nuggets.

3. The granola composition of claim 1, wherein the grain component further comprises one or more of corn, rice, wheat, rye, barley, oat groats, rolled oats, buckwheat, and soybeans.

4. The granola composition of claim 1, wherein the grain component comprises about 50% to about 85% of steel cut oats by weight.

5. The granola composition of claim 1, wherein the grain component further comprises rolled oats, crisp rice, soy crisps, or a mixture thereof.

6. The granola composition of claim 1, wherein the conditioning syrup comprises about 60° Bx to about 70° Bx.

7. The granola composition of claim 1, wherein the sugar component comprises one or more of sugar, corn syrup, molasses, and honey.

8. The granola composition of claim 7, wherein the conditioning syrup comprises about 30% to about 70% sugar by weight.

9. The granola composition of claim 1, wherein the conditioning syrup further comprises a flavoring agent, colorant, fiber additive, salt, emulsifier, preservative or a mixture thereof.

10. The granola composition of claim 1, wherein starches in the steel cut oats are hydrated.

11. The granola composition of claim 1, wherein the steel cut oats comprise a cooked texture and flavor.

12. The granola composition of claim 1, wherein the granola composition comprises about 2% to about 6% water by weight.
